(19) United States
(12) Patent Application Publication
(10) Pub. No.: US 2002/0014372 A1
(43) Pub. Date: Feb. 7, 2002

(54) Device for lubrication of a chainsaw

(75) Inventor: Dag Edlund, Huskvarna (SE)

Correspondence Address: PEARNE & GORDON LLP, 526 SUPERIOR AVENUE EAST, SUITE 1200, CLEVELAND, OH, 44114-1484, US

(73) Assignee: Aktiebolaget Electrolux

(21) Appl. No.: 09/911,595

(22) Filed: Jul. 24, 2001

(30) Foreign Application Priority Data
Jul. 27, 2000 (SE) 0002780-5

(51) Int. Cl. F16N 7/16

(52) U.S. Cl. 184/15.1

(57) ABSTRACT

A device for lubrication of a saw chain (23) where lubricant is provided from a lubrication pump and led through a first channel (12) that ends in a flat section (21) where the guide bar (22) is adjustably attached to the flat section (21). The end of the first channel (12) is shaped like a long cup (13) that is connected to the surface of the guide bar (22) and thereby making a tight seal between the first channel (12) and an inlet (25) placed inside the edges of the long cup shaped end (13) of the first channel (12) at the surface of the guide bar (22). The first channel (12) including the long cup-shaped end (13) is made of an elastic material to provide a tight seal between the first channel (12) and the surface of the guide bar (22).

### BACKGROUND OF THE INVENTION

This invention relates to a device for lubrication of a chain for an engine-powered chainsaw.

A chainsaw has a casing that includes a flat section of a metallic material to which a guide bar is adjustably attached and a device for the lubrication of a saw chain. The chain runs in a channel that surrounds the guide bar. The device for the lubrication of the chain has a channel for the transport of lubricant from the system in the chainsaw housing to the guide bar via the flat section. The lubricant flows through this transport channel and then into a second channel by an opening on the side of the guide bar. Thus, the lubricant is transported to the opening in the channel for the chain where it reduces the friction and wear.

One problem during lubrication with the previously described arrangement is leakage of the lubricant caused by insufficient sealing between the flat section and the side of the guide bar. Leakage causes a drop in the pressure in the transport channel which increases the risk for dirt and particles to fasten in the channel. A lack of lubrication of the chain increases the friction and wear of both the chain and the guide bar. The consumption of oil increases because of the leaking during both storing and use of the chain saw. Leaking oil also will cause pollution in the environment.

One solution to the problem of leaking lubricant is to make the side of the guide bar with very high precision so that the aligning to the flat section will be good. The surface of the guide bar could be, for example, a milled flat face, but this method for preparing the guide bar is expensive. This alternative to reduce the amount of leaking lubricant has not proved to be effective enough since this alternative is very sensitive to particles between the surfaces.

### BRIEF SUMMARY OF THE INVENTION

This invention eliminates the problem with leaking lubricant and provides the chainsaw with a device for reliable lubrication of the saw chain and the guide bar. The claimed invention also reduces the consumption of lubricant caused by leakage. In this new arrangement for the lubrication, the transport channel is replaced by a flexible tube made of elastic material that runs from the lubrication pump inside the casing to the flat section where the guide bar is attached. The end of the flexible tube that is placed to the side surface of the guide bar is shaped like a long cup. The edges of the cup-shaped end of the flexible tube connect to the surface of the guide bar. The elastic material makes a tight seal against the guide bar so there is no leaking lubricant. The tube has a long opening to make it possible to support the opening in the surface of the guide bar with lubricant when the position of the guide bar is adjusted in relation to the flat section.

### BRIEF DESCRIPTION OF THE DRAWINGS

FIG. 1 is a front view of an embodiment of the claimed invention;

FIG. 2 is a side view of the claimed invention in FIG. 1; and

FIG. 3 is a cross-section along the line III-III in FIG. 1, when the invention is mounted inside a chainsaw.

### DETAILED DESCRIPTION OF THE INVENTION

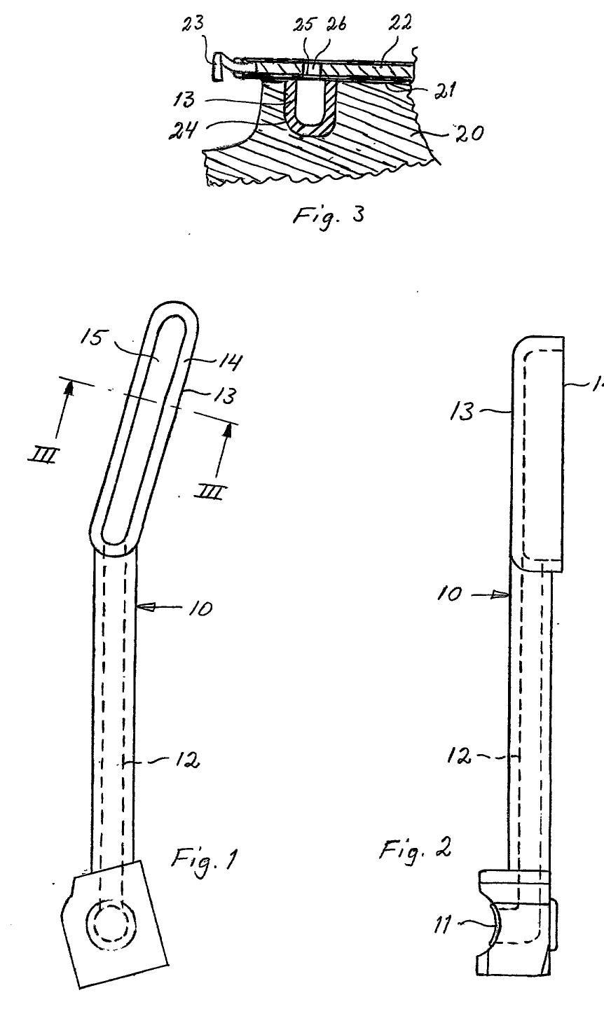

An embodiment of the invention will be described in relation to the attached drawings. The device as illustrated in FIGS. 1-2 comprises a tube-shaped device 10 with an inlet 11 at one end that is attached to a lubrication pump (not shown). The tube-shaped device 10 has a first channel 12 for the lubricant that ends in a long cup-shaped section 13. The cup-shaped section 13 is provided with a ring-shaped contact surface 14 that surrounds the outlet 15 of the first channel 12. The tube-shaped device 10, including the long cup-shaped section 13, is made in one piece of preferably an elastic material, for example, rubber.

In FIG. 3, a part of a saw casing 20 with a flat section 21 and guide bar 22 is illustrated. As in conventional chainsaws, a guide bar 22 is adjustably attached to the flat section 21 by bolts and nuts (not shown) and equipped with a saw chain 23. The fastening by bolts and nuts makes it possible to adjust the position of the guide bar 22 to change the tension in the saw chain 23. The flat section 21 in the saw casing 20 is provided with a long groove 24 sufficient to match and include the long cup-shaped section 13. The outlet 15 of the first channel 12 is placed to correspond with a second inlet 25 of a second channel 26 located inside the guide bar 22. The cup-shaped section 13 is dimensioned so that the ring-shaped contact surface 14 aligns to the surface of the guide bar 22 and encloses or surrounds the second inlet 25. Thus, no lubricant will leak out from the connection between the flat section 21 and the guide bar 22. When the position of the guide bar 22 is adjusted, the second inlet 25 moves along the long cup shaped section 13 so that there will still be a connection between the first channel 12 and the second channel 26.

The elimination of lubricant leakage in the connection between the flat section 21 and the guide bar 22 will also increase the pressure in the channel 26. A higher pressure reduces the risk that dirt and particles will block the channel 26. This ensures more equal and more reliable lubrication of the chain 23, which increases the durability of the chain 23 as well as the guide bar 22.

While the invention has been described with reference to a specific embodiment, various changes may be made and equivalents may be substituted for elements thereof by those skilled in the art without departing from the scope of the invention. In addition, other modifications may be made to adapt a particular situation or method to the teachings of the invention without departing from the essential scope thereof. The present invention herein is not to be construed as being limited, except insofar as indicated in the appended claims.

What is claimed is:

1. A device for lubrication of a chain (23) for an engine powered chainsaw comprising: a saw casing (20) provided with a flat section (21), a guide bar (22) adjustably attached to the flat section (21) and equipped with the chain (23), a first channel (12) for transportation of a lubricant to an inlet (25) of a second channel (26) located in the guide bar (22), characterized in that the first channel (12) is made of a flexible tube-shaped device (10) and an end towards the guide bar (22) is a long cup shaped section (13) with a ring-shaped contact surface (14) connected to the surface of the guide bar (22) surrounding the inlet (25).

2. A device according to claim 1, characterized in that the tube-shaped device (10) including the long cup-shaped section (13) is manufactured in one piece of elastic material.

3. A device according to claim 1, characterized in that the long cup-shaped section (13) is arranged in the length direction of the guide bar (22) to facilitate adjustments of the guide bar (22) without breaking the connection between the first and second channels (12, 26).

4. A device according to claim 2, characterized in that the long cup-shaped section (13) is arranged in the length direction of the guide bar (22) to facilitate adjustments of the guide bar (22) without breaking the connection between the first and second channels (12, 26).
